(19) United States
(12) Patent Application Publication
(10) Pub. No.: US 2024/0428230 A1
(43) Pub. Date: Dec. 26, 2024

(54) Method and Systems for Licensing Motion Capture Files with NFTs via Distributed Ledger Technology while Using AI-Based Volumetric Data and Motion Capture Technology to Create and Distribute Body Expressive Emotes for Gaming Companies and More.

(71) Applicant: Cjaiilon Antoniyo Rodriques Medina Andrade, Somerville, MA (US)

(72) Inventor: Cjaiilon Antoniyo Rodriques Medina Andrade, Somerville, MA (US)

(21) Appl. No.: 18/339,376

(22) Filed: Jun. 22, 2023

(51) Int. Cl. G06Q 20/36; G06Q 20/06

(52) U.S. Cl. CPC G06Q 20/3672; G06Q 20/065; G06Q 2220/00

(57) ABSTRACT

A method that relates to a kind of novel approach for the utilization of NFTs (Non-Fungible Tokens) as the basis for motion capture file creation and storage means that every submission carries its own unique, immutable identity. This process grants users access to a unique decentralized, non-custodial digital document storage solution on the market. The proposed system remains focused on cultivating robust systems around minting, validating, retrieving & verifying NFT-based motion capture technology. This is accomplished by the described method to mint, archive and retrieve NFT documents using a blockchain as its basis. The invention is a combination of motion capture technology, volumetric data, AI, and distributed ledger technology. The motion capture technology allows for the capture and creation of expressive body movements, while the volumetric data enhances the realism of these movements. The AI helps in the creation of unique and expressive movements, and the distributed ledger technology ensures that the ownership and distribution of these movements are securely managed.

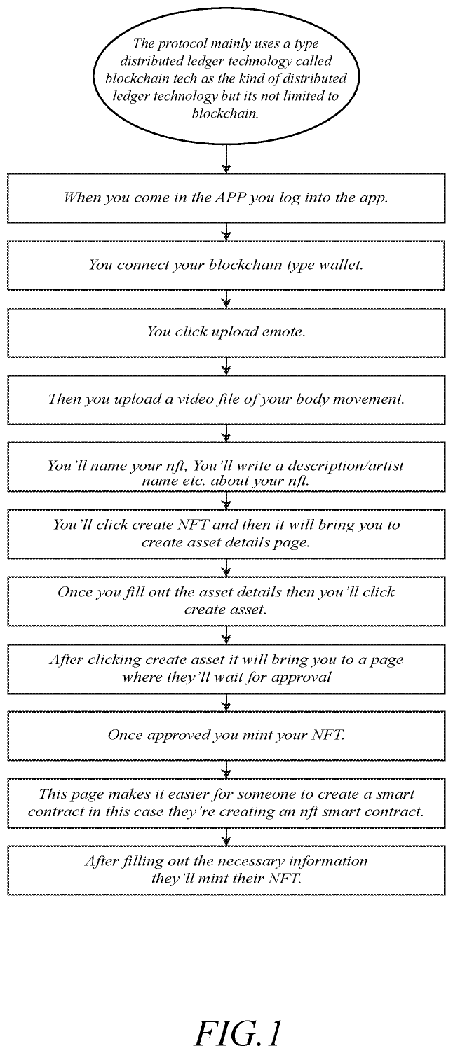

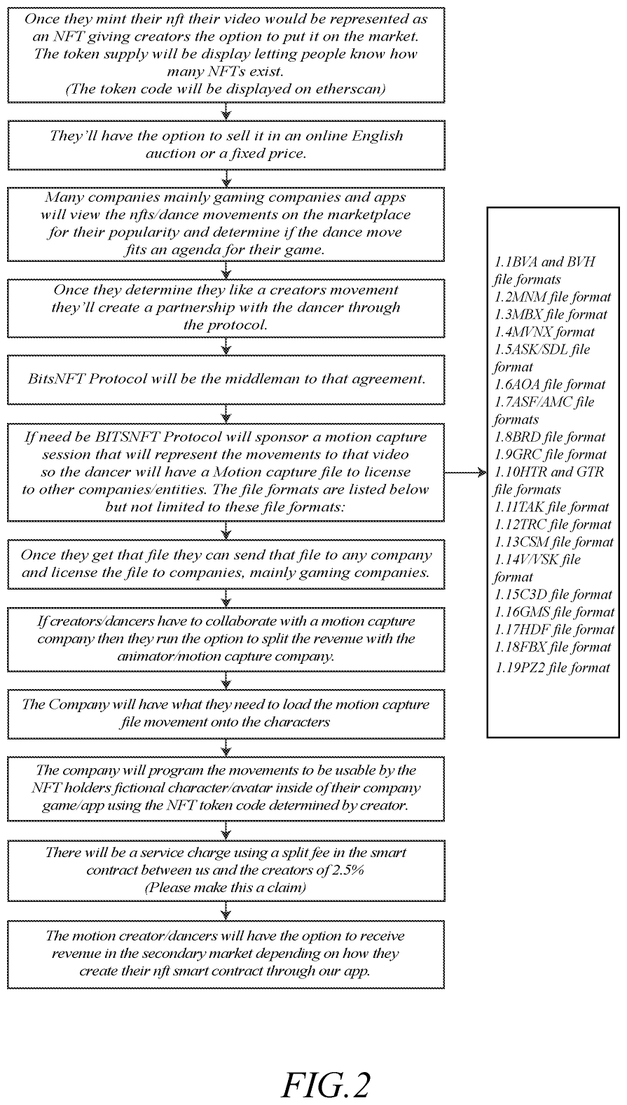

### COPYRIGHT NOTICE

A portion of the disclosure of this patent document contains material which is subject to copyright protection. The copyright owner has no objection to the facsimile reproduction by anyone of the patent disclosure, as it appears m the Patent and Trademark Office patent files or records, but otherwise reserves all copyright rights whatsoever.

### BACKGROUND

### Field of the Invention

The present invention relates generally to secure communication protocol services on a network, and more particularly, to a system and method for generating and monetizing emote Non-Fungible Tokens, using volumetric data and motion capture technology, providing a fair compensation system for body movement artists in the gaming and entertainment industries.

### Description of the Related Art

Manufacturers of high-quality videos production and art work development have long been plagued by the sale of counterfeit artwork, namely imitation that are made with the intent to deceive viewers into believing that they are viewing the actual work and is their own creativity. Similar issues exist within the digital realm, where digital products are often subject to unauthorized sale and reproduction. This unauthorized/counterfeit production and/or digital reproduction can erode a brand's value and/or exclusivity, can negatively affect a company's profitability, and may compromise a user's subjective perception of the art work as “collectable.”

Market participants and brand enthusiasts in a free market typically assign a higher value to an artwork if it is original piece of work and is never presented and replicated. While these realities are obvious in the physical real world, similar market realities also exist within a digital realm.

Within the physical world, many anti-counterfeiting techniques have been developed to help identify counterfeit work and to prevent illicit sales. Unfortunately, within the digital realm, supply is often unconstrained-if not by the original developer, then by a subsequent party who may freely (or illicitly) duplicate the digital object in its entirety. This often complicates a brand owner's ability to control the exclusivity of a digital object and/or have influence regarding the value of that object. The lack of control over digital object exclusivity then erodes the opportunity for the returns that one always expects on original creations.

Fungible tokens, like Bitcoin and other cryptocurrencies, are assets hosted on blockchain, which is a public ledger that records transactions. Non-fungible Tokens are different from fungible tokens like Bitcoin and other cryptocurrencies in that NFTs are unique assets that cannot be interchanged or divided. Fungible tokens like cryptocurrency can be exchanged with other cryptocurrency because one Bitcoin (or other cryptocurrency) has the same exact value as another Bitcoin. NFTs, on the other hand, are more like trading cards. Each NFT is something completely different from another NFT. For example, NFTs can be anything digital such as digital art or music. A famous example of an NFT is one created by Twitter founder Jack Dorsey. Dorsey created an NFT out of his first-ever Twitter post. He turned a static image of his first tweet into a digital file stored on a blockchain and then sold it for over $2.9 million. However, the licensing issue of these art works have always been a question for individuals and legal entities.

There are multiple solutions that have been presented in prior art regarding the effective utilization of NFTs and blockchain technology security in multiple ways For instance, CN patent 1,073,92608B discloses a digital asset transaction method based on a blockchain system and the blockchain system. The block chain system is a tree-shaped distributed block chain system comprising a plurality of levels of block chains, and the method comprises the following steps: the first block chain receives a digital asset transaction request from a client and determines a digital asset corresponding to the digital asset transaction request; judging whether a home block chain corresponding to the digital asset is a first block chain; if yes, the first blockchain processes the digital asset transaction request; if not, the first block chain refuses the digital asset transaction request; wherein, the attribution block chain corresponding to the digital assets is the block chain generating the digital assets. This approach is particularly useful for transactions that use a digital asset at a time, which can only be used once; in addition, the method can also realize cross-chain transaction among the digital assets, and the digital assets before and after the cross-chain transaction is executed respectively correspond to different attribution block chains, so that the safety of the assets is improved.

A CN patent 1,086,83630B implies one or more embodiments of the present specification provide a method and an apparatus for authenticating a cross-block chain, and an electronic device, which are applied to a cross-chain interaction system composed of a subscription client, a publication client, and a cross-chain client; wherein the subscribing client corresponds to a first blockchain; the publishing client corresponds to the second block chain; the cross-chain client is respectively butted with the subscription client and the publishing client; the method comprises the following steps: the subscription client acquires the data on the second blockchain published by the publishing client through the cross-chain client as an authentication data source; receiving data to be authenticated from the second blockchain; and performing data authentication on the data to be authenticated based on the authentication data source and the data authentication rule configured on the first block chain.

US patent 2,017,0132630A1 provides a system operatively connected with a block chain distributed network and for using the block chain distributed network for mapping aliases. Embodiments create an alias-token pair linking an alias associated with a customer to a token associated with an account owned by the customer; and map the alias-token pair to an address associated with the customer on a directory services (DS) block chain. In some cases, the system manages alias-token lifecycle including enabling editing and deleting the alias-token pair mapped to the address. In some cases, the system registers the address of the customer with the DS block chain. Such registering may include receiving a selection from the customer regarding desired node for registering the customer address; connecting with the DS block chain; and creating an account associated with the customer including creating a unique address associated with the customer and registering it with the DS block chain.

U.S. Pat. No. 10,749,865B2 implies Block chain/distributed ledger-based verification of entity identity or verification of a relationship between two or more entities may be provided. Verification addresses may be established on a block chain/distributed ledger by: associating identifiers and verifiers with entities having previously verified entity identities or having previously verified relationship(s) with other entities, assigning verification addresses on a block chain/distributed ledger to the entities, and recording entity identifier(s), identity verifier data and relationship verifier data associated with the entities at corresponding verification addresses. Embodiments for block chain/distributed ledger-based verification of entity identity and/or verification of entity's relationship to related entity(ies) using the verification addresses are performed using one or more identity verifiers and/or one or more relationship verifiers.

A US patent 2,017,0302663A1 implies in one embodiment, a device in a network receives a network registration request from a particular node. The network registration request comprises information about the particular node. The device causes performance of a validation of the information about the particular node via comparison of the information about the particular node to a distributed block chain that includes information regarding the particular node and one or more other nodes. The device causes an update to the block chain based on the information about the particular node and the validation of the information about the particular node. The device uses the updated block chain to control behavior of the particular node and the one or more other nodes.

A U.S. Pat. No. 11,171,782B2 discloses system and techniques for identity and electronic signature verification that utilizes blockchain technology. An enterprise system enables computing devices to engage the enterprise and prospective users for the purposes of executing a document or a smart contract. Users may obtain a computer application from an enterprise system and may utilize the computer application to retrieve a document or select a smart contract. The identity of all users who execute the document may be verified based on an authentication by a trusted independent system. Information related to the respective signers, the document or smart contract, and the authentication may be stored as transactions in a blockchain. The transactions may be stored in the blockchain under a user's address, a document or smart contract address, or a digital wallet, if available.

U.S. Pat. No. 8,543,842B2 provides systems and methods for secure transaction management and electronic rights protection. Electronic appliances such as computers equipped in accordance with the present invention help to ensure that information is accessed and used only in authorized ways, and maintain the integrity, availability, and/or confidentiality of the information. Such electronic appliances provide a distributed virtual distribution environment (VDE) that may enforce a secure chain of handling and control, for example, to control and/or meter or otherwise monitor use of electronically stored or disseminated information. Such a virtual distribution environment may be used to protect rights of various participants in electronic commerce and other electronic or electronic-facilitated transactions. Distributed and other operating systems, environments and architectures, such as, for example, those using tamper-resistant hardware-based processors, may establish security at each node. These techniques may be used to support an all-electronic information distribution, for example, utilizing the “electronic highway.”

A US patent 2,020,0065380A1 implies method, computer system, and a computer program product for document clearance is provided. The present invention may include receiving content. The present invention may also include extracting the received content features. The present invention may then include determining a level of sensitivity based on the extracted content features. The present invention may further include identifying an approver based on the determined level of sensitivity. The present invention may also include transmitting the content to the identified approver.

However, these solutions are limited and restricted to their conventional problems as discussed above. The current invention aims to provide a concept of Blockchain technology which is a non-custodial, decentralized document storage and retrieval platform, deployed within immutable native assets Non-Fungible Tokens minted on the Blockchain. This process provides a novel method and system for licensing motion capture files using non-fungible tokens (NFTs) via distributed ledger technology. The system allows users to generate and customize motion capture files using volumetric data and AI-based technology, which can be used to create and distribute body expressive emotes for gaming companies and other industries. The invention provides a new and improved way for artists and creators to monetize their work while also providing a unique and customizable experience for end-users.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved method for securely designed applications that ensure the security and authenticity of motion capture files in blockchain technology.

It is also the primary objective of the invention to provide a smart methodology directed to devices, systems and methods for facilitating non-custodial, decentralized document storage and retrieval platform, deployed within immutable native assets (NFTs) minted on the Blockchain.

It is another objective of the invention to provide a system providing real-world use-case for licensing motion capture files using non-fungible tokens (NFTs) via distributed ledger technology.

It is also the object of the invention to provide an advanced system wherein the system allows users to generate and customize motion capture files using but not limited to volumetric data and AI-based technology, which can be used to create and distribute body expressive emotes for gaming companies and other industries.

It is also the object of the invention to provide a method wherein the proposed method provides a new and improved way for artists and creators to monetize their work while also providing a unique and customizable experience for end-users.

It is a further objective of the invention to provide an advanced system where the minting of work will be verified on the blockchain environment and stored within a decentralized non-custodial vault for retrieval.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an advanced minting, storage and retrieval of immutable NFT (Non-Fungible Tokens) using the decentralized blockchain environment.

Traditionally, Non-Fungible Tokens are often used to sell digital collectibles and artwork, e.g., images, audio files, and videos. The users in the NFT ecosystem belong to one of three categories: content creator, seller, and buyer. First, the creators create digital content and upload it to hosting services (an external entity) to make the art publicly available. When it comes to selling the content, some creators are not technical enough to turn their art into an NFT, and put it as a token on the blockchain. Therefore, they authorize sellers to mint NFTs and offer it on marketplaces. In other cases, a content creator is also taking the role of the seller. Once listed on a marketplace, buyers can buy the artwork at a listed price, make offers, or place bids. If their offer is accepted or they win an auction, the NFT is transferred by invoking the transfer from ( ) API from the seller to the buyer to reflect the change in ownership. This method of transferring data provides enhanced security as compared to hand written or electronic signatures.

The system as per its preferred embodiments provides a method for licensing motion capture files using non-fungible tokens (NFTs) via distributed ledger technology and also provides a decentralized application that ensures the security and authenticity of files.

The system as per an exemplary digital asset management system may include, without limitation, a memory and a processor selectively and communicatively coupled to one another. Memory and processor may each include or be implemented by hardware and/or software components (e.g., processors, memories, communication interfaces, instructions stored in memory for execution by the processors, etc.). In some examples, memory and/or processor may be implemented by any suitable computing device. In other examples, memory and/or processor may be distributed between multiple devices and/or multiple locations as may serve a particular implementation.

The memory may maintain (e.g., store) executable data used by the processor to perform any of the operations described herein. For example, memory may store instructions that may be executed by the processor to perform any of the operations described herein. Instructions may be implemented by any suitable application, software, code, and/or other executable data instance.

The memory may also maintain any data received, generated, managed, used, and/or transmitted by the processor. The memory may store any other suitable data as may serve a particular implementation. For example, memory may store data representative of sets of collectible digital assets such as sets of collectible non-fungible digital assets, analytical information associated with use of digital assets, information regarding augmentation of digital assets, metadata associated with digital assets, notifications, graphics, and/or any other suitable data.

Processor may be configured to perform (e.g., execute instructions stored in memory to perform) various processing operations associated with digital asset management. For example, the processor may record, in a distributed record configured to track ownership of non-fungible digital assets, ownership information associated with a non-fungible digital asset that is included in a set of collectible non-fungible digital assets. These and other operations that may be performed by the processor are described herein.

The system (e.g., processor) may be configured to provide any suitable service and/or feature that may be associated with digital assets as may serve a particular implementation. For example, the system may be configured to generate digital assets, manage ownership transfer of digital assets, facilitate sharing of digital assets, facilitate augmentation of digital assets, facilitate use of digital assets, and/or provide any other suitable service and/or feature that may facilitate the management of one or more digital assets.

The System may be implemented in any suitable manner as may serve a particular application. The implementation includes a content creator computer system that is communicatively connected to a plurality of user computer systems by way of a network. Content creator computer system and user computer systems may be implemented by any suitable computing device or combination of computing devices as may serve a particular implementation. For example, content creator computer systems and/or user computer systems may be implemented by desktop computers, laptop computers, smartphones, and/or any other suitable type of computing device. System may be implemented by either the content creator computer system or user computer system. Alternatively, the system may be distributed across the content creator's computer system, user computer systems and/or any other suitable computer system.

Content creator computer system and user computer systems may communicate using any communication platforms and technologies suitable for transporting data and/or communication signals, including known communication technologies, devices, media, and protocols supportive of remote communications, examples of which include, but are not limited to, data transmission media, communications devices, and data transmission protocols.

Network may include, but is not limited to, one or more wireless networks (Wi-Fi networks), wireless communication networks, mobile telephone networks (e.g., cellular telephone networks), mobile phone data networks, broadband networks, narrowband networks, the Internet, local area networks, wide area networks, live television transmission networks, and any other networks capable of carrying media content, data, and/or communications signals between content creator computer system and user computer systems. Communications between content creator computer system and user computer systems may be transported using any one of the above-listed networks, or any combination or sub-combination of the above-listed networks. Alternatively, the content creator computer system and user computer systems may communicate in another way such as by one or more direct connections between the content creator computer system and user computer systems.

The content creator computer system may be owned or operated by an entity that creates a set of collectible non-fungible digital assets. Such an entity may use a content creator system in any suitable manner to specify content (e.g., images, videos, audio content, etc.) to be used to form set of collectible non-fungible digital assets.

System may be configured to a new process for licensing motion capture files using NFTs via distributed ledger technology. It combines the use of volumetric data and AI-based technology to generate customizable motion capture files, which can be used to create and distribute body expressive emotes for gaming companies and other industries. The parts of the invention include a distributed ledger platform, a motion capture system, and AI-based volumetric data technology. These parts work together to create and distribute unique, customizable motion capture files for end-users. The primary use of the invention is to provide a new and improved way for artists and creators to monetize their work, while also providing a unique and customizable experience for end-users. Other potential uses of the invention include, Apps, applications in the film and entertainment industry, as well as the creation of virtual reality experiences.

The protocol mainly uses a type of distributed ledger technology called blockchain tech as the kind of distributed ledger technology but it's not limited to the blockchain. The system involves an interface wherein once a user logs in or registers at the application, will connect to a blockchain-type wallet. After that user will be prompted to upload an emote/video. Once done successfully, the user can upload a video file of body movement. After that user can name the NFT and will write a description/artist name etc., through a provided interface.

As per further embodiments of the invention, after providing all required details, the user will click create NFT and then it will bring to create an asset interface page. The user will fill out the asset details. Once completed user will click create an asset. After clicking create asset it will bring to a page where waiting for approval will be displayed to the user.

As per further embodiment once approved user will mint the NFT. This page makes it easier for someone to create a smart contract in this case they're creating an NFT smart contract. After filling out the necessary information they'll mint their NFT. Once they mint their NFT their video would be represented as an NFT showing the token supply and how many exist. Furthermore, a token code will be displayed on Etherscan.

As per further embodiments of the invention, the user will have the option to sell it in an online English auction or at a fixed price. Many companies mainly gaming companies will view the NFTs/dance movements on the marketplace for their popularity and determine if the dance move fits an agenda for their game. Once determined, they will create a partnership with the dancer through the protocol.

As per further embodiments of the invention, the BitsNFT Protocol will be the middleman to that agreement. If need be BITSNFT Protocol will sponsor a motion capture session that will represent the movements to that video so the dancer will have a Motion capture file to license to other companies/entities. The file formats include but are not limited to:
1.1BVA and BVH file formats
1.2MNM file format
1.3MBX file format
1.4MVNX format
1.5ASK/SDL file format
1.6AOA file format
1.7ASF/AMC file formats
1.8BRD file format
1.9GRC file format
1.10HTR and GTR file formats
1.11TAK file format
1.12TRC file format
1.13CSM file format
1.14V/VSK file format
1.15C3D file format
1.16GMS file format
1.17HDF file format
1.18FBX file format
1.19PZ2 file format

As per further embodiments of the invention, once the file is created, the users can send that file to any company and license the file to companies, mainly gaming companies. If creators/dancers have to collaborate with a motion capture company then they run the option to split the revenue with the animator/motion capture company.

As per further embodiments of the invention, the company will have what they need to load the file movement onto the characters. The company will program the movements to be usable by the Avatar/fictional character of the NFT holders inside of their company determined by the creator. Furthermore, there will be a service charge using a split fee in the smart contract between the service provider, motion capture animators/the creators of 2.5%. The dancers will have the option to receive revenue in the secondary market depending on how they create their NFT smart contract through the application. The users will also be provided with subscription services which can be based on time period options or monetary options.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A system operatively connected with a blockchain distributed network and for using the blockchain distributed network for licensing motion capture files, the system comprising:
a memory device; and
a processing device operatively coupled to the memory device, wherein the processing device is configured to execute computer-readable program code to:
creation of unique NFT as the basis for document creation and storage; and,
mapping the immutable NFT (Non-Fungible Token) on the Blockchain, paid for through user wallet access with SecureDoc native tokens.

2. The system of claim 1, wherein the processing device is configured to execute computer-readable program code further to:
create a SecureDoc token on the Blockchain interface;

3. The system of claim 1, wherein the processing device is configured to execute computer-readable program code further to:
mint documents as immutable NFT on the Blockchain interface;

4. The system of claim 1, wherein the processing device is configured to execute computer-readable program code further to:
show the NFT token supply and how many exist, wherein the token code will be displayed on etherscan.
the owners will have the option to sell it in an online English auction or a fixed price.

5. The system of claim 1, wherein the processing device is configured to execute computer-readable program code further to:
Facilitate payment of the NFT on the Blockchain through user wallet access with the SecureDoc native tokens;
An option to split the revenue with the animator/motion capture company is presented, if creators/dancers have to collaborate with a motion capture company;
The Company will load the file movement onto the characters and will program the movements to be usable by the fictional character of the NFT holders inside of their company determined by the creator.
A service charge of using a split fee in the smart contract between the service provider and the motion capture Animator/creators of 2.5% will be practiced;

6. The system of claim 1, wherein the processing device is configured to execute computer-readable program code further to:
mint transaction holding documents submitted and verified on the proof-of-stake blockchain and stored within a decentralized non-custodial vault for retrieval;
